(19) United States
(12) Patent Application Publication
(10) Pub. No.: US 2009/0168761 A1
(43) Pub. Date: Jul. 2, 2009

(54) SIGNALING GATEWAY, NETWORK SYSTEM AND DATA TRANSMISSION METHOD

(75) Inventor: MASATO OHNISHI, Tokyo (JP)

Correspondence Address: YOUNG & THOMPSON, 209 Madison Street, Suite 500, ALEXANDRIA, VA, 22314, US

(73) Assignee: NEC CORPORATION, TOKYO (JP)

(21) Appl. No.: 12/262,865

(22) Filed: Oct. 31, 2008

(30) Foreign Application Priority Data
Dec. 27, 2007 (JP) 2007-337822

(51) Int. Cl. H04L 12/66

(52) U.S. Cl. 370/352

(57) ABSTRACT

A signaling gateway can handle the signaling communication of SS7 among the STP in PSTN and a plurality of nodes using different types of SIGTRAN protocols in the IP network. The signaling gateway includes a routing function unit which discriminates SIGTRAN protocol for each of the nodes using routing information contained in a received SS7 message from the STP, and a plurality of protocol units, each being provided for corresponding type of SIGTRAN protocol to be used for each of the nodes. The routing function unit outputs a data transfer request to the protocol unit which corresponds to the discriminated SIGTRAN protocol. The protocol unit constructs a corresponding protocol format of SIGTRAN protocol using data contained in the data transfer request and sets an originating IP address to the same value regardless the SIGTRAN protocol and a port number corresponding to the type of SIGTRAN protocol, and requests signal transmission.

This application is based upon and claims the benefit of priority from Japanese patent application No. 2007-337822, filed on Dec. 27, 2007 the disclosure of which is incorporated herein in its entirety by reference.

### TECHNICAL FIELD

The present invention relates to a signaling gateway, a network system and a data transmission method which enables communication by converting different protocols mutually for each network.

### BACKGROUND ART

SIGTRAN (Signaling Transport) is a set of protocols defined by IETF (Internet Engineering Task Force) to transport Common Channel Signaling System No. 7 (SS7) messages over IP (Internet Protocol) networks. The SIGTRAN protocol allows IP networks to inter-work with the Public Switched Telephone Network (PSTN) and vice versa.

The SIGTRAN protocol stack consists of three components, a standard IP layer, Stream Control Transmission Protocol (SCTP) and an Adaptation layer.

SCTP provides connection oriented reliable transfer of user messages between peer SCTP users (Adaptation layer protocol).

Protocols defined for the Adaptation layer are M2PA (MTP2 Peer-to-Peer Adaptation Layer), M2UA (MTP2 User Adaptation Layer), M3UA (MTP3 User Adaptation Layer) and SUA (SCCP-User Adaptation Layer).

M2PA is a protocol which supports the transport of SS7 MTP3 signaling messages over IP networks using the service of SCTP. M2PA operates so as to provide peer-to-peer communication between SS7 endpoints, and it extends an SS7 network into IP networks in a manner transparent to the SS7 network. M2UA is a protocol for backhauling of SS7 MTP2-User signaling messages over IP networks using the service of SCTP, and this protocol is used between a signaling gateway (SG) and a media gateway controller (MGC). M3UA supports the transport of any SS7 MTP3-User signaling (e.g., ISUP, SCCP and TUP messages) to an IP Signaling Point (IPSP) using the service of SCTP. SUA defines a protocol for the transport of any SS7 SCCP-user signaling message such as ICAP, RANAP or MAP over IP networks using SCTP services.

In the current 3GPP (3rd Generation Partnership Project) specification, M3UA is the only choice for signaling over IP networks in 3GPP core network However, it is proposed by 3GPP TR 29.801 to add STPs (Signal Transfer Points) in IP networks and to introduce M2PA on the interface B (i.e., a Bridge link which connects an STP to another STP). In this case, M3UA is used on the interface A (i.e., an Access link which connects a signaling end point to an STP) and M2PA is used between STPs. It means that such STP which handles the SIGTRAN protocol needs to distinguish each protocol to be used depending on an adjacent node which is connected with a signaling link (i.e., an opposite node).

In a signaling gateway which is installed in a system to connect PSTN to IP networks, when the SIGTRAN protocol is used appropriately according to the opposite node, it is necessary to hold different own IP addresses (originating IP addresses) for respective protocols and to use each IP address by discriminating the opposite node. For example, if M3UA protocol or MTP3/M2PA protocol is used according to the protocol to be used for each opposite node, it is necessary to hold two different originating IP addresses for respective connections and to use an appropriate originating IP address (i.e., an originating IP address for M3UA protocol or an originating IP address for MTP3/M2PA protocol) by discriminating the SIGTRAN protocol to be used for each opposite node.

Japanese Patent Application Laid-Open No. 2002-290551 and Japanese Patent Application Laid-Open No. 2005-184467 disclose examples of the signaling gateway using the SIGTRAN protocol which is installed in a system to connect PSTN to an IP network.

### SUMMARY

An exemplary object of the present invention is to provide a signaling gateway, a network system and a data transmission method which can handle the signaling communication of SS7 among the STP in PSTN and a plurality of opposite nodes using different types of SIGTRAN protocols in the IP network.

A signaling gateway according to an exemplary aspect of the invention includes a routing function unit which discriminates type of SIGTRAN protocol to be used for each of the opposite nodes by using routing information contained in a received SS 7 message from the STP; and a plurality of protocol units, each being provided for corresponding type of SIGTRAN protocol to be used for each of the opposite nodes, wherein the routing function unit outputs a data transfer request to the protocol unit which corresponds to the discriminated type of SIGTRA protocol, and the protocol unit constructs a corresponding protocol format of SIGTRAN protocol by using data contained in the data transfer request and sets an originating IP address which is the same value regardless the type of SIGTRAN protocol and a port number corresponding to the type of SIGTRAN protocol, and requests signal transmission.

A network system according to an exemplary aspect of the invention includes an STP provided in the SS 7 of PSTN; a plurality of Signaling End Points provided in the IP network (IPSECs) which perform signaling communication by using SIGTRAN protocols; and a signaling gateway which accommodates the STP and the IPSECs as an opposite node respectively, and performs the signaling communication of SS 7 among the STP and the IPSECs which uses different types of SIGTRAN protocols, wherein the signaling gateway constructs an appropriate protocol format to be transmitted to each of the IPSECs according to the type of SIGTRAN protocol to be used for each of the IPSECs by setting an originating IP address which is the same value regardless the type of SIGTRAN protocol and a port number corresponding to the type of SIGTRAN protocol.

A data transfer method in the signaling gateway according to an exemplary aspect of the invention includes discriminating type of SIGTRAN protocol to be used for the opposite node by using a routing information contained in a received SS 7 message from the STP; constructing a corresponding protocol format of the type of SIGTRAN protocol by using data to be transmitted in the received SS 7 message, and setting an originating IP address which is the same value regardless the type of SIGTRAN protocol and a port number corresponding to the type of SIGTRAN protocol; and transmitting the constructed protocol format to the opposite node.

### BRIEF DESCRIPTION OF THE DRAWINGS

Exemplary features and advantages of the present invention will become apparent from the following detailed description when taken with the accompanying drawings in which:

FIG. 1 shows an exemplary configuration of network system using a signaling gateway according to an embodiment of the present invention;

FIG. 2 is a block diagram showing compositions of the signaling gateway according to the embodiment of the present invention;

FIG. 3 shows exemplary contents of the signaling route information table provided in the signaling gateway according to the embodiment of the present invention;

FIG. 4 shows exemplary contents of the signaling link group information table provided in the signaling gateway according to the embodiment of the present invention;

FIG. 5 shows exemplary contents of the signaling link information table provided in the signaling gateway according to the embodiment of the present invention;

FIG. 6 shows exemplary contents of the IP signaling link information table provided in the signaling gateway according to the embodiment of the present invention;

FIG. 7 shows an example of protocol stack using M3UA protocol and M2PA protocol in the signaling gateway according to the embodiment of the present invention;

FIG. 8 shows an operation procedure of the signaling gateway according to the embodiment of the present invention;

FIG. 9 is a flowchart illustrating an operation of the signaling gateway according to the embodiment of the present invention; and

FIG. 10 is a block diagram showing a hardware configuration of the signaling gateway according to the embodiment of the present invention.

### EXEMPLARY EMBODIMENT

An exemplary embodiment of the present invention will now be described in detail in accordance with the accompanying drawings.

The following is the detailed explanation of an embodiment of the present invention with reference to drawings.

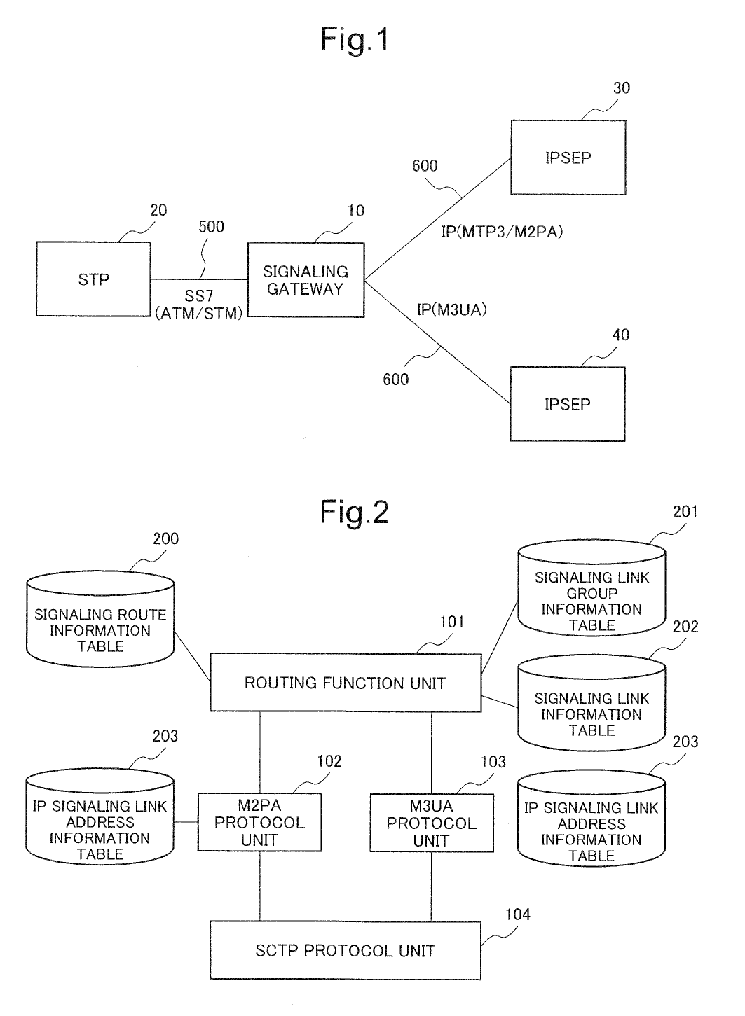

FIG. 1 shows an exemplary configuration of a network system using the signaling gateway according to the embodiment of the present invention.

The signaling gateway 10 connects signaling links for STP (Signal Transfer Point) 20 of the Common Channel Signaling System No. 7 (SS7) 500 in PSTN, IPSEP (Internet Protocol Signaling End Point) 30 and IPSEP 40 in the IP network 600. The signaling gateway 10 functions as a signaling gateway processor which converts SS 7 messages on ATM (Asynchronous Transfer Mode)/STM (Synchronous Transfer Mode) transmission lines of the SS 7 network 500 into the SIGTRAN protocol for transmitting signals in the IP network 600, and vice versa. As a result, the signaling gateway 10 enables SS7 signaling communication between PSTN and the IP network.

There exists the IPSEP 40 using M3UA protocol and the IPSEP 30 using MTP3/M2PA protocol in the IP network 600. The signaling gateway 10 uses an appropriate signaling protocol for communication with respective IPSECs by classifying a signaling link group for accommodating the IPSEP 30 and a signaling link group for accommodating the IPSEP 40.

Functional constitution of the signaling gatewaylO will be described with reference to FIG. 2.

The signaling gateway 10 includes a routing function unit 101, an M2PA protocol unit 102, an M3UA protocol unit 103 and an SCTP (stream control transmission protocol) protocol unit 104.

The signaling gateway 10 further includes a signaling route information table 200, a signaling link group information table 201, a signaling link information table 202 and an IP signaling link address information table 203, and these tables include information relating to the accommodated IPSEP 30 and IPSEP 40 which will be described later as a system data of the signaling gateway 10.

First, when an SS7 message is transmitted from the STP 20 to the signaling gateway 10, the routing function unit 101 obtains a signaling link group number of the signaling link, which is used for transmitting signals to the IP network, with reference to the signaling route information table 200. At this time, a destination point code which is included in the received SS 7 message is used as a retrieving key for searching the signaling route information table 200.

Next, the routing function unit 101 obtains link attribute information for the signaling link group, which is corresponding to the signaling link group number obtained from the signaling route information table 200, with reference to the signaling link group information table 201. At this time, the obtained signaling link group number is used as a retrieving key for searching the signaling link group information table 201. The link attribute information includes a signaling protocol to be used for the signaling link group.

Also, the routing function unit 101 obtains information relating to the signaling link which constitutes the signaling link group with reference to the signaling link information table 202. At this time, the signaling link group number obtained from the signaling route information table 200 is used as a retrieving key for searching the signaling link information table 202. The information obtained at this time includes a signaling link number.

Based on the obtained information above, the routing function unit 101 outputs a data transfer request to the M3UA protocol unit 103 or the M2PA protocol unit 102 according to the signaling protocol to be used for the signaling communication. In other words, the routing function unit 101 notifies information including obtained signaling link number to the M3UA protocol unit 103 when the opposite node uses the signaling protocol of M3UA, and to the M2PA protocol unit 102 when the opposite node uses the signaling protocol of MTP3/M2PA.

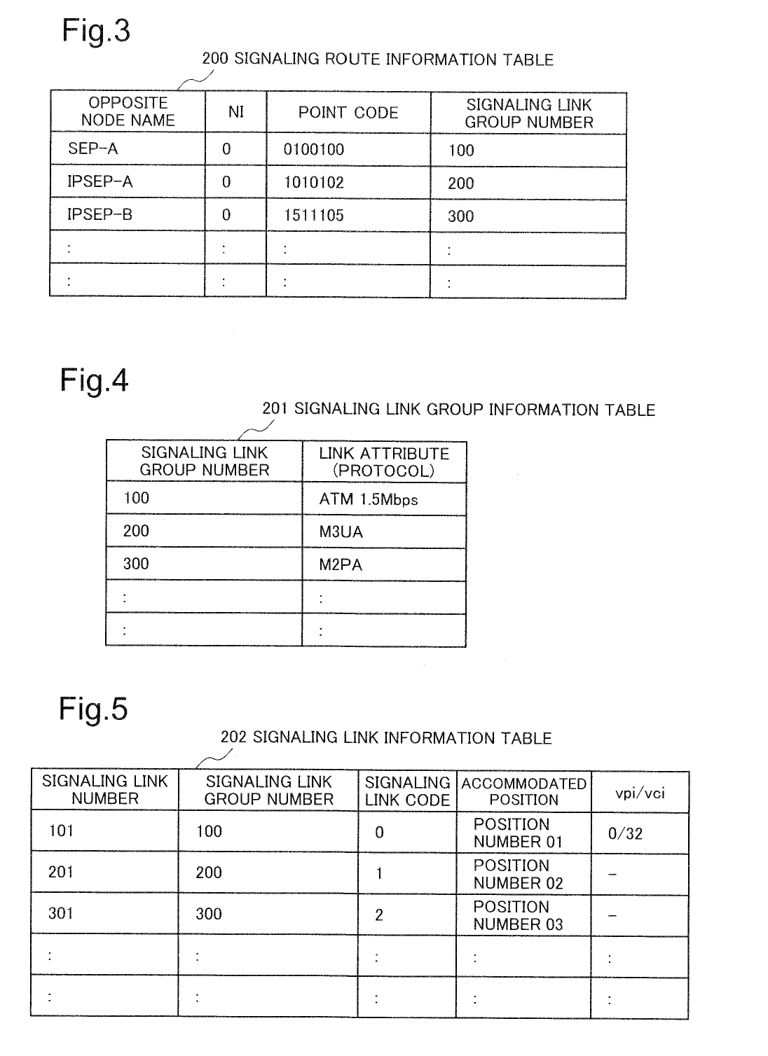

Here, FIGS. 3 to 5 show a case where the signaling link and the signaling link group correspond in 1 to 1, i.e., one signaling link constitutes one signaling link group.

When one signaling link group includes a plurality of signaling links, it may be configured in order to specify the signaling link and the signaling link group simultaneously by using the destination point code which is included in the received SS 7 message. In this case, the signaling route information table 200 may be configured in order to distinguish both of the signaling link number and the signaling link group number by using the destination point code. Thus, when the signaling route information table 200 is configured like this manner, both of the signaling link number and the signaling link group number are obtained with reference to the signaling route information table 200 by using the destination point code as the retrieving key. Then, the routing function unit 101 obtains protocol information for the signaling link group with reference to the signaling link group information table 201 by using the obtained signaling link group number as the retrieving key. Also, the routing function unit 101 obtains information relating to the signaling link with reference to the signaling link information table 202 by using the obtained signaling link number or the signaling link group number as the retrieving key.

When information on a signaling data to be transferred is notified as the data transfer request from the routing function unit 101, the M2PA protocol unit 102 obtains information on an originating IP address, a destination IP address and a port number with reference to the IP signaling link address information table 203 by using the signaling link number as a retrieving key. And then, the M2PA protocol unit 102 constructs the protocol format of M2PA, i.e., the M2PA protocol unit 102 sets the necessary information including the signaling data to be transmitted, the originating IP address, the destination IP address and the port number to the protocol format of M2PA, and requests the SCTP protocol unit 104 for signal transmission.

Similarly, when information on the signaling data to be transmitted is notified from the routing function unit 101 as the data transfer request, the M3UA protocol unit 103 obtains information on the originating IP address, the destination IP address and the port number with reference to the IP signaling link address information table 203 by using the signaling link number as a retrieving key. And then, the M3UA protocol unit 103 constructs the protocol format of M3UA, i.e., the M3UA protocol unit 103 sets the necessary information to the protocol format of M3UA, and requests the SCTP protocol unit 104 for signal transmission.

In any case of above, as the originating IP address to be set in the IP signaling link address information table 203, it is possible to set only one originating IP address which is used as the originating IP address of the signaling gateway. The port number to be set in the IP signaling link address information table 203 corresponds to the signaling protocol used for signaling communication with the opposite node, and its value is different from each other depending on the signaling protocol.

The SCTP protocol unit 104 complies with a signal transmission request received from the M2PA protocol unit 102 or the M3UA protocol unit 103 and transmits the signaling data on each protocol format to the opposite node in the IP network.

An exemplary configuration of each system data to be set in the signaling gateway 10 will be described with reference to FIGS. 3 to 6 below.

An exemplary configuration of the signaling route 5 information table 200 is shown in FIG. 3. The signaling route information table 200 includes an opposite node name given to each opposite node, a point code and a network indicator (NI) given to each opposite node, and a signaling link group number where each signaling route is accommodated. The opposite node means a node which is adjacent to the signaling gateway and is connected to the signaling gateway by a signaling link.

The required data in the signaling route information table 200 are the point code of opposite node and the signaling link group number. Both of them correspond to the opposite node name which is termed so as to maintain easily by a maintenance personnel.

An exemplary configuration of the signaling link group information table 201 is shown in FIG. 4. The signaling link group information table 201 includes the signaling link group number and its corresponding link attribute such as the transmission system (e.g., ATM/STM) and its circuit bandwidth (e.g., 1.5 Mbps/384 kbps), or protocol to be used for the signaling link group (e.g., /M3UA/M2PA).

An exemplary configuration of the signaling link information table 202 is shown in FIG. 5. The signaling link information table 202 includes the signaling link number, the signaling group number to which the signaling link belongs, a signaling code of signaling link, a physical accommodated location of the signaling gateway to which the signaling link is connected, and information about interface of the signaling link (e.g., vci (Virtual Channel Identifier)/vpi (Virtual Path Identifier)).

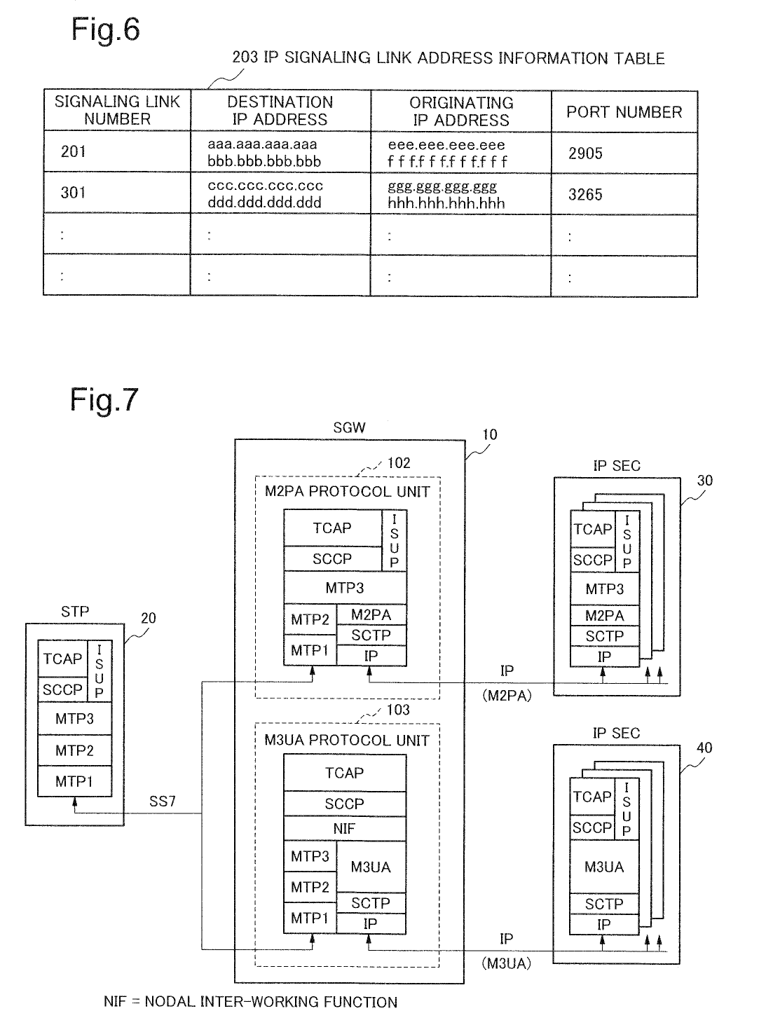

An exemplary configuration of the IP signaling link address information table 203 is shown in FIG. 6. The IP signaling link address information table 203 includes the signaling link number, the originating IP address (primary/secondary), the destination IP address (primary/secondary) and the port number used for the signaling communication.

Further, the primary IP address and the secondary IP address need to realize the SCTP multi-homing function, and a pair of IP addresses (primary/secondary) is set for one SCTP association which provides the transport for MTP3 protocol data units and M2PA adaptation layer peer messages.

Although different originating IP address is set to FIG. 6 as the originating IP address corresponding to each signaling link number, this means that it is possible to set any originating IP address arbitrarily. When the same originating IP address is used, it is possible to discriminate the signaling protocol to be used for the signaling communication with the opposite node by a combination with the originating IP address and the port number.

Also, as a port number, it is possible to allocate a standard port number corresponding to the signaling protocol, and also any port number may be allocated arbitrarily.

An example of protocol stack using M3UA and M2PA in the signaling gateway 10 is shown in FIG. 7. It shows that protocol conversion is performed by the M2PA protocol unit 102 when M2PA is used in the IP network, and protocol conversion is performed by the M3UA protocol unit 103 when M3UA is used in the IP network.

### Operation of the Embodiment

The signaling gateway 10 uses different signaling protocol appropriately depending on the signaling communication to be performed in each signaling link group which accommodates the IPSEP 30 and the IPSEP 40 respectively. Therefore, as mentioned above, the signaling gatewaylO has information about the IPSEP 30 and the IPSEP 40, which are opposite nodes, in advance as the signaling route information table 200, the signaling link group information table 201, the signaling link information table 202 and the IP signaling link address information table 203. These information tables are set and stored as system data of the signaling gateway 10.

Here, how the signaling gatewaylO uses the SIGTRAN protocol appropriately by referring to each system data (e.g., each information table) will be explained.

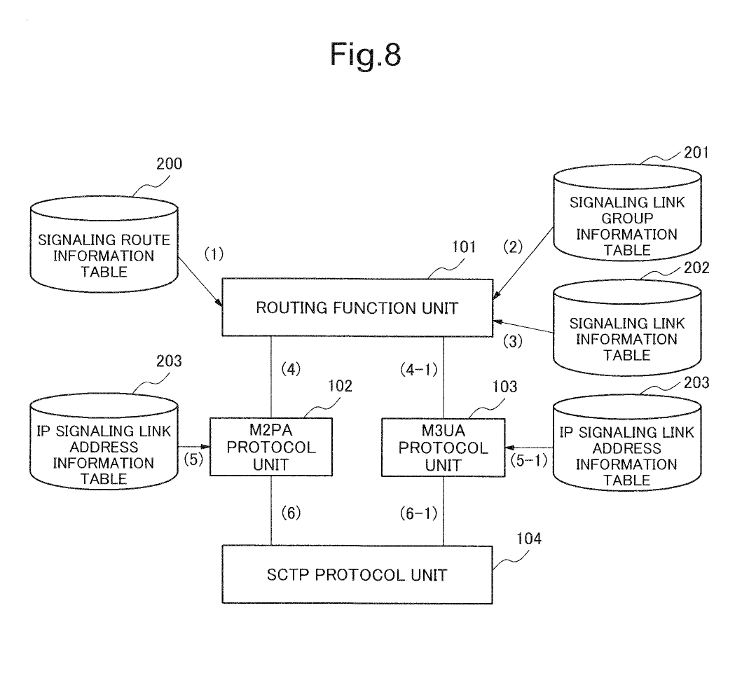

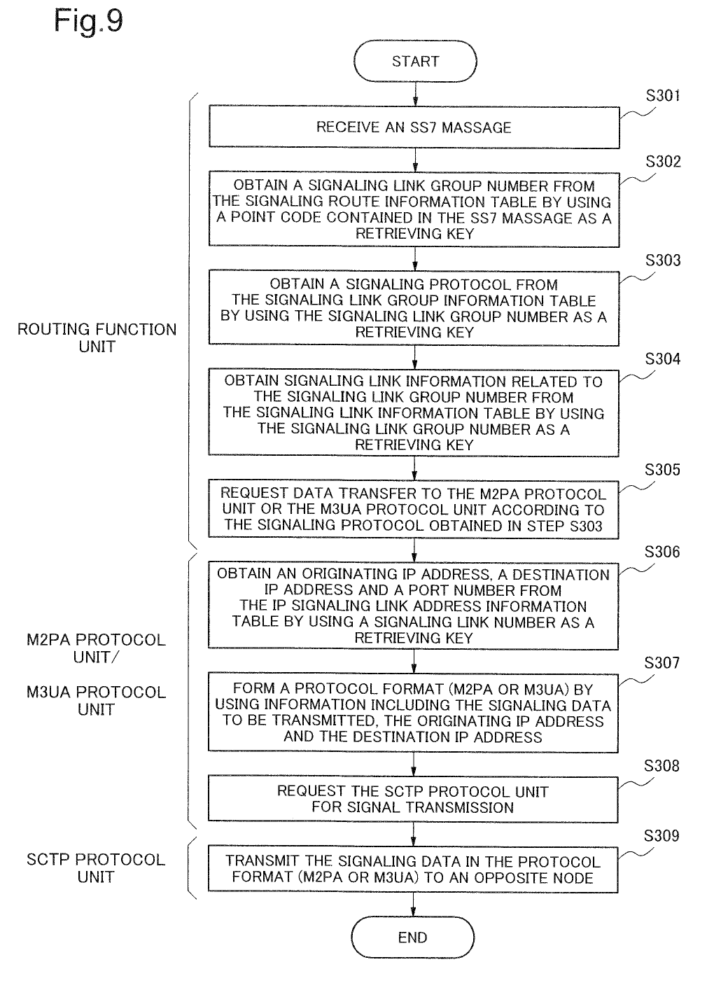

Hereinafter, operation of the signaling gatewaylO will be described with reference to FIGS. 8 and 9. FIG. 8 shows an operation procedure of the signaling gateway10 and FIG. 9 is a flowchart.

When the SS 7 message is transmitted from the STP 20 of PSTN (Step S301), the routing function unit 101 of the signaling gateway10 refers to the signaling route information table 200 shown in FIG. 3 by using a destination point code included in the received SS 7 message.

And then, the routing function unit 101 obtains a signaling link group number corresponding to the destination point code from the signaling route information table200 (StepS302, and procedure (1) of FIG. 8).

After that, the routing function unit 101 refers to the signaling link group information table 201 shown in FIG. 4 by using the obtained signaling link group number as a retrieving key information (Step S303, and procedure (2) of FIG. 8). By referring to the signaling link group information table 201, it is possible to derive the signaling protocol information such as M3UA/M2PA which is used by the signaling link group.

Also, the routing function unit 101 obtains information on a signaling link number which is included in the signaling link group, an accommodated location in which the physical signaling link is accommodated, and an interface for the signaling link by referring to the signaling link information table 202 shown in FIG. 5 by using the signaling link group number as a retrieving key information (Step S304, and procedure (3) of FIG. 8).

Further, the routing function unit 101 sends a data transfer request to the M3UA protocol unit 103 when the signaling protocol obtained from the signaling link group information table 201 is M3UA (procedure (4-1) of FIG. 8). When the signaling protocol obtained from the signaling link group information table 202 is M2PA, the routing function unit 101 sends the data transfer request to the M2PA protocol unit 102 (Step S305, and procedure (4) of FIG. 8)

Next, when the signal data and related information to be transmitted are received from the routing function unit 101, the M2PA protocol unit 102 (or the M3UA protocol unit103) refers to the system data of IP signaling link address information table 203 shown in FIG. 6 (Step S306, and procedure (5) and (5-1) of FIG. 8).

The M2PA protocol unit 102 (or the M3UA protocol unit 103) obtains information on a destination IP address, an originating IP address and a port number used for the signaling communication from the IP signaling link address information table 203 by using the signaling link number included in the data transfer request transmitted from the routing function unit 101 as a retrieving key.

As the originating IP address to be set in the IP signaling link address information table 203, it is possible to set the same originating IP address for both of the M3UA protocol and the M2PA protocol.

However, the port number to be used for each of the M3UA protocol and the M2PA protocol should be different from each other, i.e., different port number is used for respective protocols. The following method can be used to set the port number to the IP signaling link address information table 203.

The first method is a method by which the maintenance personnel sets the port number to the IP signaling link address information table 203 in advance for each signaling protocol.

The second method is a method not to set the port number by the maintenance personnel, but to set it by program control. In this case, a system data setting program obtains signaling protocol for the relevant signaling link with reference to the signaling link group information table 201 shown in FIG. 4, and it sets a default port number, which is specified by RFC 3332 corresponding to each signaling protocol, to the IP signaling link address information table 203. When the M3UA protocol is used, the default port number “2905” is set, and when using the M2PA protocol, the default port number “3565” is set to the IP signaling link address information table 203.

When the originating IP address, the destination IP address and the port number are obtained from the IP signaling link address information table 203, the M2PA protocol unit 102 (or the M3UA protocol unit 103) sets a signal data to be transmitted and information on the originating IP address and the destination IP address to the protocol format of the M2PA (or M3UA) (Step S307), and requests signal transmission to the SCTP protocol unit 104 (Step S308, and procedure (6) and (6-1) of FIG. 8).

The SCTP protocol unit 104 transmits the signal data to the opposite node complying with the signal transmission request received from the M2PA protocol unit 102 or the M3UA protocol unit 103 (Step S309).

### The Effect by the Embodiment

According to the exemplary embodiment, it becomes possible to accommodate a plurality of opposite nodes using different SIGTRAN protocol (e.g., an opposite node using M3UA and an opposite node using MTP3/M2PA), and also it becomes possible to use the same originating IP address regardless what signaling protocol is used for each of the opposite nodes. That is, the signaling gateway according to the exemplary embodiment can use different SIGTRAN protocol appropriately by discriminating each signaling link group accommodated in the signaling gateway, and it is enough to hold one originating IP address regardless what signaling protocol is used for each of the opposite nodes.

That is, according to the exemplary embodiment, a system to use the SIGTRAN protocol appropriately depending on the accommodated signaling link group can be realized by allocating the port number differently according to the SIGTRAN protocol to be used.

Also, system management by the maintenance personnel can be simplified substantially, because a plurality of IP addresses are not needed for different signaling protocols.

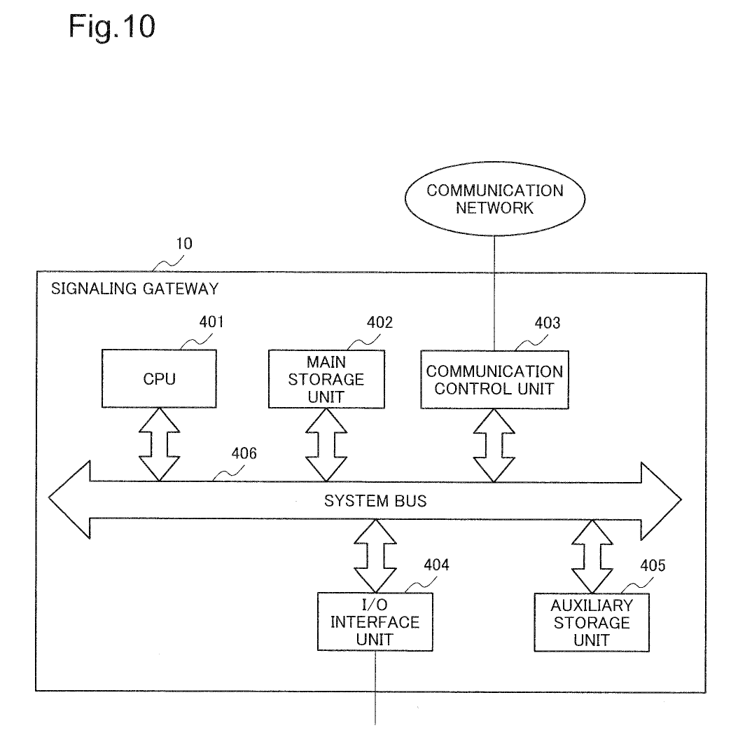

Next, a hardware configuration of the signaling gateway10 will be described with reference to FIG. 10. FIG. 10 is a block diagram showing a hardware configuration of the signaling gateway10.

The signaling gateway10 can be realized by the same hardware configuration as a general computer. The signaling gateway10 includes CPU (Central Processing Unit) 401, a main storage unit 402, a communication control unit 403, an I/O interface unit part 404, an auxiliary storage unit 405 and a system bus406. The main storage unit 402 is a main memory such as RAM (Random Access Memory), and it is used for a temporary data save area and a working area of data. The communication control unit 403 transmits and receives data via a communication network. The I/O interface unit 404 connects with an external apparatus and transmits and receives data. The auxiliary storage unit 405 includes a hard disk apparatus including a non-volatile memory such as ROM (Read Only Memory), a magnetic disk and a semiconductor memory. The system bus 406 connects each component mutually.

The signaling gateway10 according to the exemplary embodiment can realize its operation like a hardware apparatus by installing a circuit element of hardware component such as LSI (Large Scale Integration) in which a program for performing each function mentioned above is built-in. The signaling gateway10 according to the exemplary embodiment can realize its operation based on software. In this case, each program which provides the function of the routing function unit 101, the M2PA protocol unit 102, the M3UA protocol unit 103 and the SCTP protocol unit 104 is stored in the auxiliary storage unit 405, and the CPU 401 performs the program which is loaded in the main storage unit 402. The system data of the signaling route information table 200, the signaling link group information table 201, the signaling link information table 202 and the IP signaling link address information table 203 are stored in the auxiliary storage unit 405.

On the contrary, the related art described in the background art causes a problem which needs different originating IP address in the signaling gateway for each of SIGTRAN protocols to be used for respective opposite nodes, i.e., it is necessary for the signaling gateway to use different originating IP address according to the SIGTRAN protocol to be used for the signaling communication with the opposite node. Therefore, there is a problem that the system management by the maintenance personnel becomes troublesome.

An exemplary advantage according to the present invention is that the signaling gateway can use the SIGTRAN protocol appropriately regardless the signaling protocol to be used for the signaling communication with any opposite node without setting a plurality of originating IP addresses as the system data.

In the above-mentioned embodiment, M3UA and M2PA are used as an example of the SIGTRAN protocol for explanation purpose, however, other SIGTRAN protocols such as SUA and M2UA may be used as the protocol to be used.

While this invention has been particularly shown and described with reference to exemplary embodiments thereof, the invention is not limited to those specific embodiments. It will be understood by those of ordinary skill in the art that various changes in form and details may be made therein without departing from the spirit and scope of the present invention as defined by the claims.

Further, it is the inventor's intention to retain all equivalents of the claimed invention even if the claims are amended during prosecution

What is claimed is:

1. A signaling gateway which performs signaling communication of Common Channel Signaling System No. 7 (SS7) among a Signal Transfer Point (STP) in Public Switched Telephone Network (PSTN) and a plurality of opposite nodes using different types of SIGTRAN (Signaling Transport) protocols defined by IETF (Internet Engineering Task Force) in IP (Internet Protocol) network, the signaling gateway comprising:
a routing function unit which discriminates type of SIGTRAN protocol to be used for each of the opposite nodes by using routing information contained in a received SS 7 message from the STP; and
a plurality of protocol units, each being provided for corresponding type of SIGTRAN protocol to be used for each of the opposite nodes,
wherein the routing function unit outputs a data transfer request to the protocol unit which corresponds to the discriminated type of SIGTRAN protocol, and the protocol unit constructs a corresponding protocol format of SIGTRAN protocol by using data contained in the data transfer request and sets an originating IP address which is the same value regardless the type of SIGTRAN protocol and a port number corresponding to the type of SIGTRAN protocol, and requests signal transmission.

2. The signaling gateway according to claim 1, further comprising a system data which defines information on the type of SIGTRAN protocol corresponding to a signaling link group number of the opposite node which is derived from the routing information contained in the received SS 7 message, the originating IP address which is the same value regardless the type of SIGTRAN protocol, and the port number corresponding to a signaling link number of the opposite node which is derived from the signaling link group number,
wherein the routing function unit obtains the signaling link group number and the signaling link number from the system data by using a destination point code of the routing information contained in the received SS 7 message, obtains the type of SIGTRAN protocol corresponding to the obtained signaling link group number from the system data, and outputs the data transfer request including the signaling link number to the protocol unit which is corresponding to the obtained type of SIGTRAN protocol, and the protocol unit obtains the originating IP address and the port number corresponding to the signaling link number from the system data for constructing the protocol format.

3. The signaling gateway according to claim 2, wherein the port number to be set in the system data is a predetermined different value according to the type of SIGTRAN protocol which is corresponding to the signaling link number.

4. The signaling gateway according to claim 3, wherein the system data comprising:
a signaling route information table which includes the signaling link group number corresponding to the destination point code of the route information contained in the received SS 7 message;
a signaling link group information table which includes the type of SIGTRAN protocol corresponding to the signaling link group number obtained from the signaling route information table;
a signaling link information table which includes the signaling link number corresponding to the signaling group number obtained from the signaling route information table; and
an IP signaling link address information table which include the originating IP address and the port number corresponding to the signaling link number obtained from the signaling link information table,
wherein the routing function unit obtains the signaling link group number from the signaling route information table by using the destination point code as a retrieving key, obtains the type of SIGTRAN protocol from the signaling link group information table by using the signaling link group number as the retrieving key, obtains the signaling link number from the signaling link information table by using the signaling link group number as the retrieving key, and outputs the data transfer request, in which the signaling link number obtained from the signaling link information table is included, to the protocol unit corresponding to the obtained type of SIGTRAN protocol, and
wherein the protocol unit obtains the originating IP address and the port number from the IP signaling link address information table by using the signaling link number included in the data transfer request as the retrieving key for constructing the protocol format.

5. A network system which interworks for signaling communication of Common Channel Signaling System No. 7 (SS7) between Public Switched Telephone Network (PSTN) and IP (Internet Protocol) network, comprising:
a Signaling Transfer Point (STP) provided in the SS 7 of PSTN;
a plurality of Signaling End Points provided in the IP network (IPSECs) which perform signaling communication by using SIGTRAN (Signaling Transport) protocols defined by IETF (Internet Engineering Task Force); and
a signaling gateway which accommodates the STP and the IPSECs as an opposite node respectively, and performs the signaling communication of SS 7 among the STP and the IPSECs which uses different types of SIGTRAN protocols,
wherein the signaling gateway constructs an appropriate protocol format to be transmitted to each of the IPSECs according to the type of SIGTRAN protocol to be used for each of the IPSECs by setting an originating IP address which is the same value regardless the type of SIGTRAN protocol and a port number corresponding to the type of SIGTRAN protocol.

6. The network system according to claim 5, wherein the signaling gateway comprising:
a routing function unit which discriminates the type of SIGTRAN protocol to be used for each of the IPSECs by using a routing information contained in a received SS 7 message from the STP; and
a plurality of protocol units, each being provided for corresponding type of SIGTRAN protocol to be used for each of the IPSECS,
wherein the routing function unit outputs a data transfer request to the protocol unit which corresponds to the discriminated type of SIGTRA protocol, and the protocol unit constructs a corresponding protocol format by using data contained in the data transfer request and sets the originating IP address which is the same value regardless the type of SIGTRAN protocol and the port number corresponding to the type of SIGTRAN protocol, and requests signal transmission.

7. The network system according to claim 6, wherein the signaling gateway further comprising a system data which defines information on the type of SIGTRAN protocol corresponding to a signaling link group number of the IPSEC which is derived from the routing information contained in the received SS 7 message, the originating IP address which is the same value regardless the type of SIGTRAN protocol, and the port number corresponding to a signaling link number of the IPSEC which is derived from the signaling link group number,
wherein the routing function unit obtains the signaling link group number and the signaling link number from the system data by using a destination point code of the routing information contained in the received SS 7 message, obtains the type of SIGTRAN protocol corresponding to the obtained signaling link group number from the system data, and outputs the data transfer request including the signaling link number to the protocol unit which is corresponding to the obtained type of SIGTRAN protocol, and the protocol unit obtains the originating IP address and the port number corresponding to the signaling link number from the system data for constructing the protocol format.

8. The network system according to claim 7, wherein the port number to be set in the system data is a predetermined different value according to the type of SIGTRAN protocol which is corresponding to the signaling link number.

9. A data transmission method used in a signaling gateway which performs signaling communication of Common Channel Signaling System No. 7 (SS7) among a Signal Transfer Point (STP) in Public Switched Telephone Network (PSTN) and a plurality of opposite nodes using different types of SIGTRAN (Signaling Transport) protocols defined by IETF (Internet Engineering Task Force) in IP (Internet Protocol) network, the method comprising:
discriminating type of SIGTRAN protocol to be used for the opposite node by using a routing information contained in a received SS 7 message from the STP;
constructing a corresponding protocol format of the type of SIGTRAN protocol by using data to be transmitted in the received SS 7 message, and setting an originating IP address which is the same value regardless the type of SIGTRAN protocol and a port number corresponding to the type of SIGTRAN protocol; and
transmitting the constructed protocol format to the opposite node.

10. The data transmission method according to claim 9, wherein the signaling gateway includes a system data which defines information on the type of SIGTRAN protocol corresponding to a signaling link group number of the opposite node which is derived from the routing information contained in the received SS 7 message, the originating IP address which is the same value regardless the type of SIGTRAN protocol, and the port number corresponding to a signaling link number of the opposite node which is derived from the signaling link group number,
wherein the discriminating step includes;
obtaining the signaling link group number and the signaling link number from the system data by using a destination point code of the routing information contained in the received SS 7 message; and
obtaining the type of SIGTRAN protocol corresponding to the obtained signaling link group number from the system data,
wherein the constructing step includes;
obtaining the originating IP address and the port number corresponding to the signaling link number from the system data for constructing the protocol format.

11. The data transmission method according to claim 10, wherein the port number to be set in the system data is a predetermined different value according to the type of SIGTRAN protocol which is corresponding to the signaling link number.

12. The data transmission method according to claim 11, wherein the signaling gateway further includes a routing function unit for discriminating the type of SIGTRAN protocol to be used for each of the opposite nodes and a plurality of protocol units, each being provided for corresponding type of SIGTRAN protocol to be used for each of the opposite nodes,
wherein the discriminating step, being performed by the routing function unit, further includes;
outputting a data transfer request including the obtained signaling link number to the protocol unit which is corresponding to the obtained type of SIGTRAN protocol,
wherein the constructing step, being performed by the protocol unit which is corresponding to the type of SIGTRAN protocol having been discriminated in the discriminating step, includes;
constructing the corresponding protocol format of the type of SIGTRAN protocol by using data contained in the data transfer request received from the routing function unit, and setting the originating IP address which is the same value regardless the type of SIGTRAN protocol and the port number corresponding to the signaling link number included in the received data transfer request.
